(19) United States
(12) Patent Application Publication
(10) Pub. No.: US 2008/0114777 A1
(43) Pub. Date: May 15, 2008

(54) Data Structure for an Electronic Document and Related Methods

(75) Inventors: Manuel Angel Albarran Moyo, Barcelona (ES); Andrew Mackenzie, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/571,075

(22) PCT Filed: Aug. 27, 2004
(86) PCT No.: PCT/EP04/51940

§ 371 Date: Sep. 13, 2007

(30) Foreign Application Priority Data
Sep. 10, 2003 (GB) 0321171.1

(51) Int. Cl. G06F 17/30

(52) U.S. Cl. 707/100; 707/E17.001

(57) ABSTRACT

A data structure which defines an electronic document comprises first and second substantially separate portions of data. The first portion of data defining the content of the document and the second portion comprising data relating to a pattern of position identification markings (106) such that when the electronic document is printed a pattern reading device, such as a pen (300), is able to determine its position relative to the position identification markings.

### FIELD OF THE INVENTION

This invention relates to a data structure for an electronic document and related methods.

### BACKGROUND OF THE INVENTION

It is known to use documents having position identification markings in combination with a pattern reading device such as a digital pen. The device may have an imaging system, such as an infra red camera, within it, which is arranged to image a small area of the page close to the pen nib. The pen includes a processor having image processing capabilities and a memory and is triggered by a force sensor in the nib to record images from the camera as the pen is moved across the document. From these images the pen can determine the position of any marks made on the document by the pen. The pen markings can be stored directly as graphic images, which can then be stored and displayed in combination with other markings on the document. In some applications the simple recognition that a mark has been made by the pen on a predefined area of the document can be recorded, and this information used in any suitable way. This allows, for example, forms with check boxes on to be provided and the marking of the check boxes with the pen to be detected. In further applications the pen markings are analysed using character recognition tools and stored digitally as text. Systems using this technology are available from Anoto AB and described on their website www.Anoto.com.

It will be appreciated that in order to use a pen and a document using the position identification markings it is necessary to have media, generally paper, on which the position identification markings have been provided. This media may comprise a plain media, or may comprise a form or the like on which information is provided in addition to the position identification markings. A user may then use his/her pen to add to the media whether or not it has such additional information.

Prior art solutions have provided content (e.g. a layout of a form, etc.) and metadata (i.e. data about the position identification markings) in a variety of formats. Prior solutions have suffered from problems of marrying the correct content to the correct metadata to produce the document required by the user.

### SUMMARY OF THE INVENTION

According to a first aspect of the invention there is provided a data structure which defines an electronic document, the data structure comprising first and second substantially separate portions of data; the first portion of data defining the content of the document and the second portion comprising data relating to a pattern of position identification markings such that when the electronic document is printed a pattern reading device, such as a pen, is able to determine its position relative to the position identification markings.

The data structure most conveniently comprises a single data file with the first and second data portions being embedded within the data file.

The skilled man will understand that in using the term data structure we mean a set of data which is stored in a structured manner. For example it may be electronic data stored in the memory of a computer or across a number of computers or memories. A single data file defining a data structure, such as a single electronic data file, can typically be identified as a collection of data that can be accessed through a single, common, file descriptor, such as a file name. There must exist something that links the data together to form the single file, perhaps by storing them together or naming each piece of data with a common identifier that links them. This common link allows all of the data to be accessed or moved together at the request of the user.

An advantage of such a data structure is that it provides a convenient means of storing the electronic document. As such it may be simpler than prior art systems to transfer the electronic document defined by the data structure to various locations between processing apparatus, etc., to electronically process the document and the like. A user can access both the content and the pattern data from a single file, and the content and pattern will not be easily separated. The electronic document can be printed out in hard copy, thus providing a digital document for use with a digital pen. The pattern and content may be superimposed in this digital document.

The data structure may be written in such a form that the data structure may be converted from one format to other formats without losing any of the information from the file, particularly information about the pattern. This may be achieved by providing the second portion of data as metadata and providing one or more controls which control the way in which the second portion of data is converted between formats to preserve the pattern. In one embodiment of the invention the second portion of data may comprise XMP language meta-data (Extensible Metadata platform) data. This can be embedded in a data structure saved in the following formats: a PDF format (Portable Document Format as provided by the Adobe™ corporation); JPEG (Joint Photographic Experts Group); SVG format (Scalable Vector Graphics); GIF (Graphics Interchange Format); TIFF (Tagged Image File Format); PNG (Portable Network Graphics).

Use of the XMP format for the metadata means that the data structure can readily be converted using proprietary software known in the art between these formats whilst preserving the pattern information defined by the data. Any software which can scan a file for metadata will be able to identify the pattern data as distinct from the content and so determine which pattern is needed when printing. For a more detailed explanation of such XMP metadata the reader is referred to “Embedding XMP Metadata in Application files”, June 2002, Adobe Systems Incorporated, 345 Park Avenue, San Jose, Calif. 95110-2704, USA.

It is preferred that the content in the data structure is stored in a graphical format with pattern metadata embedded within the data structure. The graphical format could be a bitmap or vector based format.

Prior art data structures are limited in their flexibility as they do not provide such data defining a pattern of position identification markings in the same file as the content yet in a separate portion of the file allowing it to be moved across formats. For example, in the past a single bitmap or vector formal file defining both pattern and content suitable for sending to a printer is known. Such a data structure cannot be converted to other formats since specific information indicating which part of the data structure is pattern data and which is content data is not available. If this information is lost as the file is converted to another format the pattern could be lost or corrupted and then the electronic document cannot be printed correctly.

The first portion could also contain data other than content data, such as metadata defining the content or other information. The content data could define text characters or graphical marks or other human-identifiable and/or readable information. Of course, in some situations it could comprise zero content in which case the digital document, when printed, may be blank other than for a pattern of positional markings.

The second portion defining the pattern may comprise metadata. By this we mean “data about data”. This metadata may completely define a portion of pattern needed to print the digital document such that it can be understood by a printer driver or a printer and rendered to form the pattern. It could alternatively comprise an entry of information which is a self-describing definition of a portion of pattern within a pattern space.

For example, the metadata information about the pattern contained in the data structure may comprise the co-ordinates of at least one corner of a portion of pattern from a two-dimensional pattern space and optionally its size. If the space is fully characterised by a two-dimensional co-ordinate system this is all that is needed for a suitably enabled printer driver to generate the pattern. Additionally or alternatively, it may define the length of a side of at least one side of the portion, the shape of the portion or a set of absolute co-ordinates defining the boundary of the portion in the pattern space.

The metadata which is embedded in the second portion of the data structure may identify the location of a portion of pattern in a pattern space in many other ways. It could be a pointer to a server on which the pattern is stored, or which is capable of allocating the pattern to the document. To be useful a pattern space should be very large allowing it to be allocated to many hundreds or thousands of documents such that each document is allocated a unique portion of pattern. To make this more manageable the pattern space could be divided according to rules into sub-regions of known size, each of which may be referred to as a shelf of position identification markings. Each of the shelves may be further subdivided into individual pages. Within each page an (X,Y) co-ordinate may be defined for each point within the page of position identification markings to define any portion of the position identification markings used within a printed document. In this case, the data embedded in the second data portion may comprise data identifying both a shelf, a page on that shelf and the co-ordinates of a portion of pattern within that page.

Providing data about the pattern as metadata within a file in this way ensures that together with some knowledge of the rules which define the pattern space the document contains all the information needed to print the correct content with the correct pattern. All that is needed is knowledge of the pattern space the portion is selected from.

In other words, an algorithm or the like may generate the portion of pattern from the data by identifying co-ordinates or other meta-data identifying the portion of the position identification marking.

The data structure may comprise a data file written in a mark up language such as XML and the second portion of data may comprise XML metadata embedded within the data file. The data file may be in any one of a number of different formats for example PDP. It could in fact be in any known language which can be interpreted by a suitable printer driver or printer.

According to a second aspect of the invention there is provided a method for generating an electronic document comprising: creating an electronic file and storing in that file at least some content and at least some position identification markings arranged to allow a pattern reading device to determine its position within the position identification markings, the electronic file being capable of generating an electronic document.

The method may allow the electronic document to be converted from a first file format, in which it is stored, to a second file format. The first and second formats may be any one of the following: a PDF format (Portable Document Format as provided by the Adobe™ corporation); JPEG (Joint Photographic Experts Group); SVG format (Scalable Vector Graphics); GIF (Graphics Interchange Format); TIFF (Tagged Image File Format); PNG (Portable Network Graphics); or any other suitable file format.

According to a third aspect the invention provides a digital document production application suitable for producing a data structure defining a digital document comprising:

content receiving means for receiving the content of the digital document; pattern receiving means for receiving data defining a pattern of position identification markings allocated to at least a portion of the document; and data structure generating means for generating a data structure defining the digital document which data structure comprises a first portion of data defining the content and a second portion of data defining the pattern.

The content receiving means may include a graphical user interface. This may present to a user an image of a document on a screen to which a user can add content. Alternatively, it may call up a content file containing content. The content file could be a text file from a word processing package, or a spreadsheet from a database or a drawing from a drawing package. It may obtain content from more than one file.

The pattern receiving means may include a means for requesting pattern from a server or from a store of locally held pattern information. The program may make this request once a user has indicated that the design of the document content is complete.

The data structure may be generated by the program automatically once a user has indicated that the design of the content is complete.

Of course, it will be readily understood that a technically competent user could produce such a data structure directly using a text editor. The program of this aspect of the invention makes the process considerably simpler and allows users of low technical ability to produce digital documents.

According to a fourth aspect of the invention there is provided a data carrier containing instructions which when read onto a computer cause that computer to perform the method of the second aspect of the invention or provide the application of the third aspect.

According to a fifth aspect of the invention there is provided a data carrier containing instructions which when read onto a computer provide the electronic document of the first aspect of the invention.

The data carrier of any of the above aspects of the invention can comprise a floppy disk, a CDROM, a DVD ROM/RAM (including +RW, −RW), a hard drive, a non-volatile memory, any form of magneto optical disk, a wire, a transmitted signal (which may comprise an internet download, an ftp transfer, or the like), or any other form of computer readable medium.

According to a further aspect of the invention there is provided a source file for a printed digital document, the printed document comprising content and a pattern of position identification markings arranged to allow a pattern reading device to determine its position within the position identification markings, the source file comprising at least a first portion defining the content and a second portion comprising metadata which comprises a self-defining description of the pattern.

Preferred embodiments of a data structure defining a digital document in accordance with the present invention will now be described by way of example only with reference to the accompanying drawings in which:

### BRIEF DESCRIPTION OF THE DRAWINGS

FIG. 1 shows a digital document created from an embodiment of a data structure according to an embodiment of the present invention;

FIG. 2 shows in detail part of the digital document of FIG. 1;

FIG. 3 shows a prior art digital pen for use with the document of FIG. 1;

FIG. 4 is a flow diagram showing a method of generating a digital document in accordance with an embodiment of the present invention;

FIG. 5 shows the allocation of pattern space to the document of FIG. 1, in accordance with an embodiment of the present invention;

FIG. 6 shows an electronic file defining the document of FIG. 1, in accordance with an embodiment of the present invention.

### DETAILED DESCRIPTION OF THE PREFERRED EMBODIMENTS

Referring to FIG. 1 a digital document 100 for use in a digital pen and paper system comprises a carrier 102 in the form of a single sheet of paper 104 with position identifying markings 106 printed on some parts of it to define pattern areas 107 of a position identifying pattern 108. Also printed on the paper 104 are further markings 109 which are clearly visible to a human user of the document 100. Theses markings make up the content of the document 100. The content 109 will obviously depend entirely on the intended use of the document. In this case an example of a very simple two page questionnaire is shown, and the content includes a number of boxes 110, 112 which can be pre-printed with user specific information such as the user's name 114 and a document identification number 116. The content further comprises a number of check boxes 118 any one of which is to be marked by the user, and two larger boxes 120, 121 in which the user can write comments. The document content also includes a send box 122 to be checked by the user when he has completed the questionnaire to initiate a document completion process by which pen stroke data is forwarded for processing, and typographical information on the document 100 such as the headings or labels 124 for the various boxes 110, 112, 118, 120. The position identifying pattern 108 is only printed onto the parts of the document 100 which the user is expected to write on or mark, that is within the check boxes 118, the comments boxes 120, 121 and the send box 122.

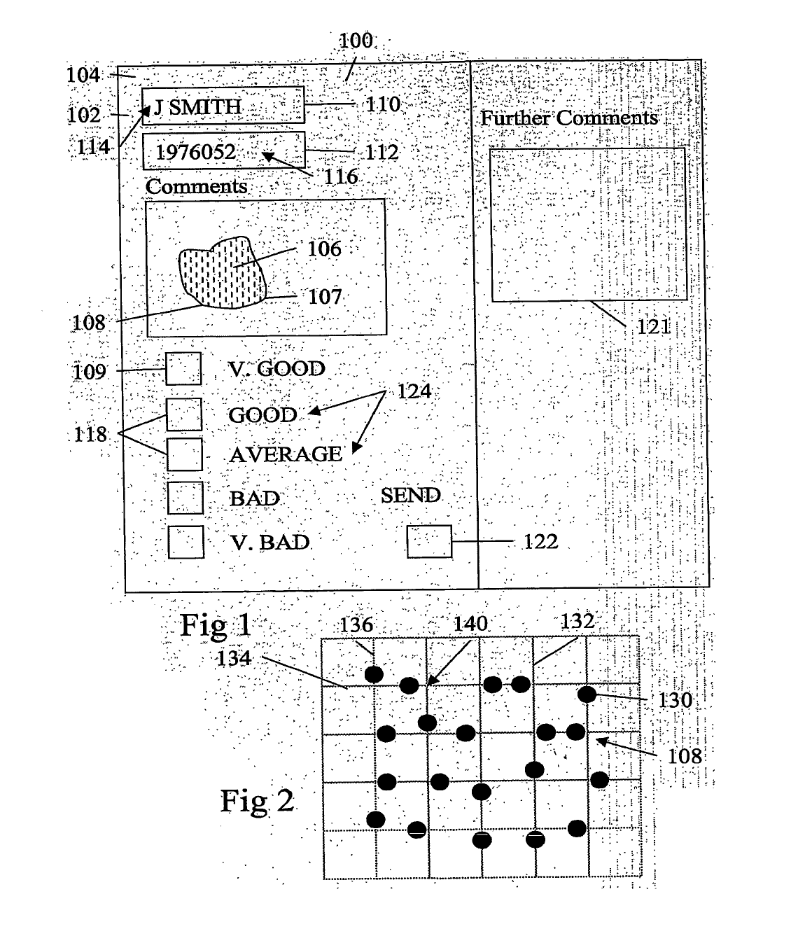

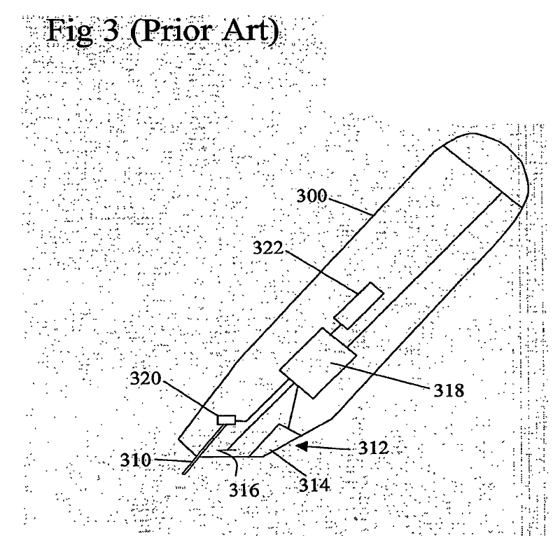

Referring to FIG. 2, the position identifying pattern 108 is made up of a number of dots 130 arranged on an imaginary grid 132. The grid 132 can be considered as being made up of horizontal and vertical lines 134, 136 defining a number of intersections 140 where they cross. The intersections 140 are of the order of 0.3 mm apart. One dot 130 is provided at each intersection 140, but offset slightly in one of four possible directions up, down, left or right, from the actual intersection 140 by about ⅙^{th} of the grid spacing. The dot offsets are arranged to vary in a systematic way so that any group of a sufficient number of dots 130, for example any group of 36 dots arranged in a six by six square, will be unique within a very large area of the pattern. This large area is defined as a total imaginary pattern space, and only a small part of the pattern space is taken up by the pattern on the document 100. By allocating a known area of the pattern space to the document 100, for example by means of a co-ordinate reference, the document and any position on the patterned parts of it can be identified from the pattern printed on it. An example of this type of pattern is described in WO 01/26033. It will be appreciated that other position identifying patterns can equally be used. Some examples of other suitable patterns are described in WO 00/73983 and WO 01/71643.

Referring to FIG. 3, a pattern reading device comprising a pen 300 comprises a writing nib 310, and a camera 312 made up of an infra red (IR) LED 314 and an IR sensor 316. The camera 312 is arranged to image a circular area of diameter 3.3 mm adjacent to the tip 311 of the pen nib 310. A processor 318 processes images from the camera 312. A pressure sensor 320 detects when the nib 310 is in contact with the document 100 and triggers operation of the camera 312. Whenever the pen is being used on a patterned area of the document 100, the processor 318 can therefore determine from the pattern 108 the position of the nib of the pen whenever it is in contact with the document 100. From this the processor can determine the position and shape of any marks made on the patterned areas of the document 100. This information is stored in a memory 320 in the pen as it is being used. When the user has finished marking the document, in this case when the questionnaire is completed, this is recorded in a document completion process, for example by making a mark with the pen in the send box 122. The pen is arranged to recognise the pattern in the send box 122 and determine from that pattern the identity of the document 100. Suitable pens are available from Logitech under the trade mark Logitech Io.

The foregoing discussion is related to known systems and preferred embodiments of the present invention are described hereinafter.

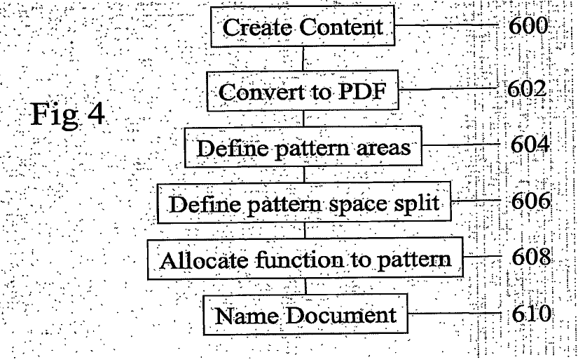

In order to produce a digital document 100, the first step is the design and creation of an electronic document file containing content. The electronic document can be printed as a hard copy digital document or displayed on a screen. Referring to FIG. 4, the design of the content of the document is carried out on a PC using an application (Step 600). In this example the application is Acrobat Reader and the PC also runs a number of other applications including a word processing package such as ‘Word’ a database package such as ‘Access’, and a spreadsheet package such as ‘Excel’. Each of these applications can be used to design the content of the document. The user defines areas of the document to which the pattern 108 are to be applied, for example, a digital document creation application or form design tool (FDT) in the form of an Acrobat 5.0 plug-in.

In this example the content is converted to a Portable Document Format (PDF) file (Step 602). Pattern areas for the document are then defined using the FDT (Step 604). The split of the pattern areas within the document is defined (Step 606) producing a digital document defining both the content and the positions and shapes of the pattern areas. The format of this digital document will again comprise a PDF file, the data structure of which will be described hereinafter. Of course, it will be appreciated that the steps of designing the content and the pattern could both be performed by the FDT.

Depending on the FDT, the pattern areas 107 can be defined in terms of their absolute positions, sizes and shapes on the document, or in relation to the content, such as by an indication of which of the boxes 114, 116, 118, 120, 121, 122 are to have the pattern 108 printed in them. Alternatively, the pattern areas 107 can be defined by a combination of their absolute positions, sizes and shapes on the document, and in relation to the content printed in them.

Association of a pattern area 107 with a content feature, such as a check box, can be used such that moving the content feature within the document design moves the associated pattern area 107 with it. This is helpful when designing and modifying the document. Although, a specific pattern area 107 is associated with each of the printed boxes 118, 120, 121, 122, the pattern areas 107 do not have to correspond exactly to the areas of the printed boxes 118, 120, 121, 122. Each of the pattern areas 107 will generally be made larger than the box 118, 120, 121, 122 with which it is associated. This allows for inaccurate positioning of a user made mark upon the page, whilst ensuring that the pen 300 will still be able to detect where the mark is on the page.

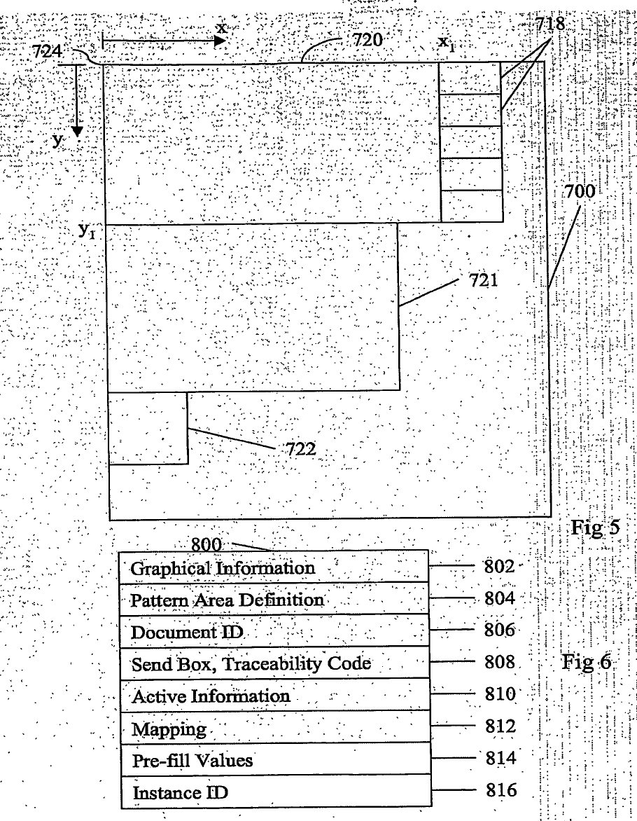

The pattern areas 107 have respective positions within the total pattern space area allocated to them. These allocated positions within the total pattern space are requested from, and allocated by, a pattern allocating server. Referring to FIG. 5, a single page 700 of pattern space required for the document 100 can be broken down by the FDT into a number of separate pattern space areas 718, 720, 721, 722. These pattern space areas 728, 720, 721, 722 are to be allocated to the respective boxes 118, 120, 121, 122 on the document 100 (Step 606). These pattern space areas 718, 720, 721, 722 are arranged on the page 700 of pattern space in any suitable way. In particular, the relative positions of the pattern space areas 718, 720, 721, 722 on the pattern space page 700 can differ from their relative positions on the final document 100.

Each area is identified by its coordinates on the page 700. In this case it is assumed that all allocated pattern space areas will be rectangular, and each is identified by the position of its top left and bottom right corners. The coordinate system used has its origin at the top left hand corner 724 of the page and includes an x coordinate indicating the distance to the right of the origin, and a y coordinate indicating the distance down from the origin. The pattern space area 720, for example, is identified by the coordinates (0,0; x₁y₁).

It would of course be possible to use other co-ordinate systems. For example, some embodiments may store co-ordinates for a corner and a depth and height of the rectangular area. Other embodiments may not assume that the areas are rectangular. They may assume, for example, that the area is circular and as such store a co-ordinate for the centre of the area together with a radius and/or diameter for the area. Other embodiments can specify the shape of the area (for example square, circular, elliptical, and the like) and then store information defining that area.

Functions associated with the various patterned areas, if any, 718, 720, 721, 722 are defined (Step 608). This allows an application using the document 100 to process data received back when the document 100 has been written on. In the case of the questionnaire document 100 the pattern areas in the larger boxes 120, 121 are identified as a graphical input areas, for which any pen markings should be stored graphically, or perhaps. analysed using character recognition and stored as text. The pattern associated with the check boxes 118 is associated with the respective response options so that the checking of the boxes 118 on a number of the documents 100 produces a standard mark, such as a cross, in the check box of the stored document.

Finally the designed electronic document 100 is saved as a single electronic document file and allocated a document name (Step 610).

Upon completion of the design of the document 100 a data structure (in this example a PDF file 800) will have been created, as shown in FIG. 6. The PDF file 800 comprises a first portion which includes graphical information 802 defining the content of the document 100, and a second portion 804 which comprises a pattern area definition defining the sizes and positions of the pattern areas 107 on the document 100.

Also as shown in FIG. 8, the file may contain other, optional, features. For example, the file 800 may also contain information relating to the functions (if any) associated with the pattern areas on the document 100 and the relative positions of the pattern areas within the pattern space page 700 allocated to the document 100.

Additionally, the PDF file 800 may contain a document ID 806, a traceability code 808 of the pattern associated with the send box 122, and other active information 810, associated with pattern areas other than the send box 122. The traceability code 808 and active information 810 are used when the pattern areas upon the document 100 are passed over by the digital pen 300 such that a correlation between the location of a pattern area within the document and the pattern area's activity can be established by a processor, either within the pen 300 or remote from the pen 300.

The PDF file 800 may also contain mapping information 812 for mapping data from databases or other sources onto the document 100. For example data such as the location of the user's name 114 and document ID number 116 within the database 414 can be extracted therefrom. Also, if pre-filled fields are used within the document 100 values 814 for filling these pre-filled fields can be extracted from the database 414. For example, the user's name 114 and ID 116 can be extracted from the database 414 and automatically printed upon the document 100.

The PDF file 800 also contains, as in this example, a document instance ID 816 which is unique to the individual document to be printed. Usually, this data is not placed into the file 800 until the time of printing. Normally, there will only be one printed document with a particular instance ID 816 so that individual documents can be tracked and identified. However, in some instances it is desirable to be able to print more than one copy of exactly the same document with the same document instance ID 816, for example in secret ballots where anonymity is desirable. Therefore provision is made to allow the printing of more than one copy of a given document with the same instance ID 816.

Thus, the PDF file 800 basically provides a data structure comprising a first portion of data relating to content of the document 100 (i.e. the graphical information 802) and a second portion of metadata relating to position identification markings within the document (i.e. pattern area definition 804). The pattern data indicates which portions of an overall position identification pattern space have been used within a document and the location of these portions within the document. Such a data structure allows a device, such as a pen 300, to determine its position within the position identification markings and what content is located at the current position of the pen 300. Of course, the document defined by the data structure must be printed before it can be used with the pen (or perhaps displayed on a screen).

The data structure entries relating to position identification markings within the document can include semantic data about graphical items, typical graphical items include a check box, or a text box. For example, the information that the text box is to be used to introduce a phone number can be linked to the text box, as can which portion of the overall position identification pattern relates to the text box. This semantic data for the text box is stored as metadata within the PDF file 800.

The details of a server which is to be contacted for access permissions, control and tracking of the overall position identification pattern are also typically stored as metadata within the PDF file 800. Similarly, details of how to print the portion of the overall position identification pattern that relates to the text box, perhaps using the server, and data relating to the pattern printing rights and/or licences can also be embedded within the PDF file 800, typically as XML data.

The data structure entries relating to position identification markings within the document and/or data identifying content within the electronic document 100 may be thought of as metadata (i.e. data about data).

In one embodiment, the metadata (for example XML) is embedded within the PDF file 800 and is used to provide a self-describing representation of the position identification markings. Appendix A shows a sample XML file where “Pattern(X,Y)” details which section of the overall position identification pattern is to be inserted within a document and “Page(X,Y)” describes the position of the section of position identification pattern within a page of a document to be printed. “Layer” describes the layer where the section of position identification pattern will be pasted. This “Layer” descriptor is useful where an overlap of sections of position identification pattern occurs, as the layer with the lowest “Layer” value will be printed. “IsMagicBox” is merely an attribute for the section of position identification pattern contained within the document.

The metadata may be organised into related groups of properties. For example, the groups may be relevant certain modules in a system used to manage, distribute and print an electronic document provided by the PDF file 800. The groups may be implemented as schemas that define an XML namespace, such that elements and attributes can have the same name but originate from differing sources. This allows mark up elements within an XML file from the differing sources to be identified.

A set of rules are also defined in order to preserve the metadata when a file is opened and then saved in a file format different to that in which it was opened.

When transcribing between file formats the original representation used in the writing of the metadata should be preserved in the output. Custom properties can be added to a document such as a PDF file, each custom property having a name and a value. These “name”/“value” pairs are stored within the data file as metadata and when a file's format is changed the metadata is transcribed to the correct location within the new file format keeping pairs together.

For example, in an embodiment of a data structure which is the form of a PDF file the portion of data defining pattern may be an XML packet containing metadata relating to the position identification pattern. The pattern data is contained in a metadata stream within a PDF object within the file. On the other hand, if the data structure is in the form of a JPEG file, and the pattern data is again provided in an XML packet, the file will use a marker (known as an APP1 marker) to designate the location of the XML packet containing the position identification pattern metadata. Therefore, when transcribing a PDF file to a JPEG file the XML packet containing the position identification pattern metadata should be transcribed to the correct location within the APP1 marker of the JPEG file and vice-versa. Similar transcriptions of metadata location data must take place when changing between any file formats, such as GIF, PNG, TIFF, SVG or any other suitable file format.

Therefore, because the metadata is enclosed within a file 800 as metadata, documents retain their context when they exit their original system or environment. Thus, the form and properties of the documents are preserved when the program that uses the documents is not the final authority, i.e. when the program used to read, represent and translate the properties is a different program from that used to create the metadata.

Use of metadata for pattern information enables users to store, retrieve, distribute and share digital paper documents that can be easily and correctly viewed by any user with access to them. Further, the electronic document file 800 having metadata embedded therein allows a single file 800 to be distributed for a given document rather than needing to distribute multiple files, each relating to a separate property of the document. The use of separate multiple files describing a single document has a number of disadvantages including managing a plurality of versions, ensuring all of the files relate to the same version of the document, and the increased risk of loss or corruption of a single file resulting in the loss of a complete document. Providing a single file 800 results in the data content and metadata of the file 800 being edited at the same time. Further, the embedded metadata may include XML schema.

Further, the metadata can be embedded using a file embedding mechanism that allows applications to more easily locate metadata in files by scanning of the file 800 rather than needing to parse a specific applications file format. Such an arrangement makes the metadata more accessible and further aid document interchange and management.

In an alternative embodiment the metadata is embedded within the data defining the pattern areas 718, 720, 721, 722 as an invisible font in the file 800. For example, text characters are defined in a predetermined manner by a string of data, and part of the string for each character defines the font in which the character will be printed. The data defining the pattern areas 718, 720, 721, 722 is therefore put into the format of a series of text characters, with a non-valid font definition so that they will not be printed as characters by the printer. In this embodiment a printer or other processing device used to print the file 800, or otherwise process it, is arranged to recognize the non-printable text characters, by means of the non-valid font definition. The printer, or other processing device, interprets the data defining the non-printable text characters in a different manner to standard, printable, text characters as identifying the size, shape, and position of the required pattern areas 718, 720, 721, 722. The non-valid font definition either provides the pattern of the position identification markings or provides instructions as to how the printer can obtain the pattern, typically from a networked resource, such as a server.

The definition of the pattern areas 718, 720, 721, 722 can be further enhanced by means of tags at the ends of the data string defining them. These tags alert the printer, or other processing device, to the fact that the data between them is to be interpreted as a definition of the pattern areas 718, 720,721, 722.

Thus, when the PDF file 800 is sent for printing each graphic object contained within the PDF file 800 is received by the printer and the valid graphic objects are printed in the conventional manner. Those characters with non-valid font definitions are interpreted such that the pattern areas 718, 720, 721, 722 are printed in their defined areas of the document.

In the embodiments described hereinbefore it is stated that the creation of the data set defining the digital document is performed by a form design tool, requiring pattern to be allocated at the design stage. This need not be the case in other embodiments. For example, the data structure may be created by a printer driver upon receipt of a file which comprises content and a file which defines at least one pattern area. Before receipt by the printer driver the area need not have actual pattern allocated to it, this being performed by the printer driver, perhaps by accessing a pattern allocation server.

The output of such a printer driver would be a data structure in accordance with at least one embodiment of the present invention. Also, it is possible that the output of the form design tool could be an embodiment of a data structure which is within the scope of at least one aspect of the invention.

The output of the FDT may comprise a data structure which includes a portion of data defining content and a second portion of data which defines the location of pattern areas within the document rather than the location of pattern for those areas within pattern space. As before, this second portion of data may comprise metadata about where in the document pattern is to be placed. As an example, the metadata may indicate that the designed document is to contain some pattern at its upper left corner, and that the pattern is to cover one third of the page. The printer driver—upon reading this metadata—allocates an appropriate portion of pattern and replaces the original metadata with new metadata defining the position of a portion of pattern in pattern space.

```
APPENDIX A
- <Document DLDVersionNumber=“0” DLDSubVersionNumber=“1”
  DLDPrintableVersionNumber=“0.1” NumberOfForms=“1”>
  -
    <FormnumberOfPages=“1”formID=“gfggg”userdata=“Not
    Used”formInstanceID=“”templateID=“PODTemplateV1”
    local=“0”standardSize=“A4”pagesizeheight=“0”
    pagesizewidth=“0”>
  - <FormPagepageOrientation=“Portrait” tcX=“0”
      tcY=“601” initialXMargin=“0” initialYMargin=“0”>
      <DrawingArea patternX=“1402” patternY=“1165”
        pageX=“597” pageY=“891” width=“82”
        height=“82” layer=“1” IsaMagicBox=“0” />
      <DrawingArea patternX=“1126” patternY=“365”
        pageX=“321” pageY=“91” width=“124”
        height=“64” layer=“1” IsaMagicBox=“0” />
      <DrawingArea patternX=“1301” patternY=“365”
        pageX=“496” pageY=“91” width=“159”
        height=“74” layer=“1” IsaMagicBox=“0” />
    </FormPage>
  </Form>
</Document>
```

1.-14. (canceled)

15. A data structure which defines an electronic document, the data structure comprising first and second substantially separate portions of data; the first portion of data defining the content of the document and the second portion comprising data relating to a pattern of position identification markings such that when the electronic document is printed a pattern reading device, such as a pen, is able to determine its position relative to the position identification markings, the data structure comprising a single data file with the first and second data portions being embedded within the data file.

16. A data structure according to claim 15 which is written in such a form that the data structure can be converted from one format to other formats without losing any of the information from the document.

17. A data structure according to claim 15 in which the second portion of data comprises metadata and in which the data structure includes one or more controls which control the way in which the second portion of data is converted between formats to preserve the pattern.

18. A data structure according to claim 16 in which the second portion of data comprises metadata and in which the data structure includes one or more controls which control the way in which the second portion of data is converted between formats to preserve the pattern.

19. A data structure according to claim 15 in which the data in the second portion comprises any one or more of the following: data from which an algorithm or the like can generate the pattern; co-ordinates or other metadata identifying the portion of the position identification marking.

20. A data structure according to claim 16 in which the data in the second portion comprises any one or more of the following: data from which an algorithm or the like can generate the pattern; co-ordinates or other metadata identifying the portion of the position identification marking.

21. A data structure according to claim 17 in which the data in the second portion comprises any one or more of the following: data from which an algorithm or the like can generate the pattern; co-ordinates or other metadata identifying the portion of the position identification marking.

22. A data structure according to claim 18 in which the data in the second portion comprises any one or more of the following: data from which an algorithm or the like can generate the pattern; co-ordinates or other metadata identifying the portion of the position identification marking.

23. A data structure according to claim 15 in which the at least one portion providing the position of the position identification markings within the document and/or data identifying the content of the position identification marking in the document is provided in XML.

24. A data structure according to claim 16 in which the at least one portion providing the position of the position identification markings within the document and/or data identifying the content of the position identification marking in the document is provided in XML.

25. A data structure according to claim 17 in which the at least one portion providing the position of the position identification markings within the document and/or data identifying the content of the position identification marking in the document is provided in XML.

26. A data structure according to claim 18 in which the at least one portion providing the position of the position identification markings within the document and/or data identifying the content of the position identification marking in the document is provided in XML.

27. A data structure according to claim 19 in which the at least one portion providing the position of the position identification markings within the document and/or data identifying the content of the position identification marking in the document is provided in XML.

28. A data structure according to claim 20 in which the at least one portion providing the position of the position identification markings within the document and/or data identifying the content of the position identification marking in the document is provided in XML.

29. A data structure according to claim 21 in which the at least one portion providing the position of the position identification markings within the document and/or data identifying the content of the position identification marking in the document is provided in XML.

30. A data structure according to claim 22 in which the at least one portion providing the position of the position identification markings within the document and/or data identifying the content of the position identification marking in the document is provided in XML.

31. A data structure according to claim 15 in which a schema, generally an XML schema, is provided.

32. An application adapted to produce an electronic document, the application comprising:
content receiving means for receiving the content of the electronic document, pattern receiving means for receiving data defining a pattern of positional markings allocated to at least a portion of the document; and
data structure generating means for generating a data structure defining the electronic document which data structure comprises first and second substantially separate portions of data, the first portion of data defining the content and the second portion of data relating to the pattern.

33. A method for generating an electronic document comprising creating an electronic file and storing in that file data and metadata, the data defining at least some content and the metadata relating to a pattern of position identification markings arranged to allow a device, such as a pen, to determine its position within the position identification markings, the electronic file capable of generating an electronic document.

34. A method according to claim 33 in which a file embedding mechanism is used to embed metadata, generally XML metadata, within the electronic document.
